(19) United States
(12) Patent Application Publication
(10) Pub. No.: US 2006/0250368 A1
(43) Pub. Date: Nov. 9, 2006

(54) Keyboard slot structure

(75) Inventors: Beniz Wang, Banciao City (TW); Tien-Ming Chan, Taipei City (TW)

Correspondence Address: Genus Law Group PLLC, Box 26219, Crystal City Station, Arlington, VA, 22215, US

(73) Assignee: Inventec Corporation

(21) Appl. No.: 11/124,733

(22) Filed: May 9, 2005

(51) Int. Cl. G09G 5/00

(52) U.S. Cl. 345/168

(57) ABSTRACT

A keyboard slot structure comprises a keyboard slot and a keyboard, which can be placed in the keyboard slot. The keyboard slot provides enough storage space for the keyboard, and on its lengthwise side, there is an opening. In addition, on the two lateral sides of the keyboard slot, there are two automatic outward gliding devices for the keyboard. A press button is located properly on the internal side corresponding to the opening of the keyboard slot. The keyboard includes a conventional keyboard, and on its external edge, there is a fixation column corresponding to the press button. With this structure, users can place the keyboard into the keyboard slot, or make the keyboard gliding out of keyboard slot via a slight pressing action.

### BACKGROUND OF THE INVENTION

1. Field of the Invention

The present invention relates generally to a keyboard slot structure, and more particularly to a keyboard slot structure, which is attached on a special computer peripheral, such as the monitor, and provides keyboard storage function.

2. Description of Related Art

For current conventional desktop computer, its keyboard is always separate from its main body or monitor mostly, that is to say, there is no place for keyboard placement on its main body or monitor. When the computer is to be relocated, the keyboard must be disconnected for individual handling, otherwise it would cause inconvenience in handling.

### SUMMARY OF THE INVENTION

The present invention relates generally to a keyboard slot structure, which consists of a keyboard slot and a keyboard which can be placed in the keyboard slot. The keyboard slot provides enough storage space for the keyboard, and on its lengthwise side, there is an opening. In addition, on the two lateral sides of the keyboard slot, there are two automatic outward gliding devices for the keyboard. A press button is located on the internal side, corresponding to the opening of the automatic outward gliding device. The keyboard comprises a conventional keyboard, and on its external edge, there is a fixation column corresponding to the press button. With this structure, users can place the keyboard into the keyboard slot, or make the keyboard gliding out of keyboard slot via a slight pressing action.

### BRIEF DESCRIPTION OF THE DRAWINGS

FIG. 1 shows a preferred embodiment of the keyboard slot structure at the bottom of a monitor;

FIG. 2 shows a decomposed view of the keyboard slot structure;

FIG. 3 shows a schematic diagram of the keyboard to be locked in the keyboard slot;

FIG. 4 shows a schematic diagram of the keyboard locked in the keyboard slot; and

FIG. 5 shows a schematic diagram of the keyboard gliding outward from the keyboard slot.

### DETAILED DESCRIPTION OF THE PREFERRED EMBODIMENT

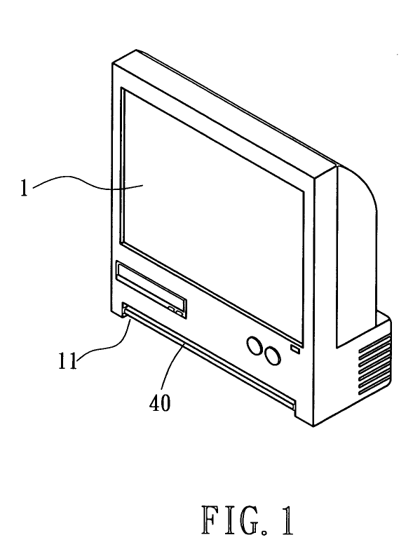

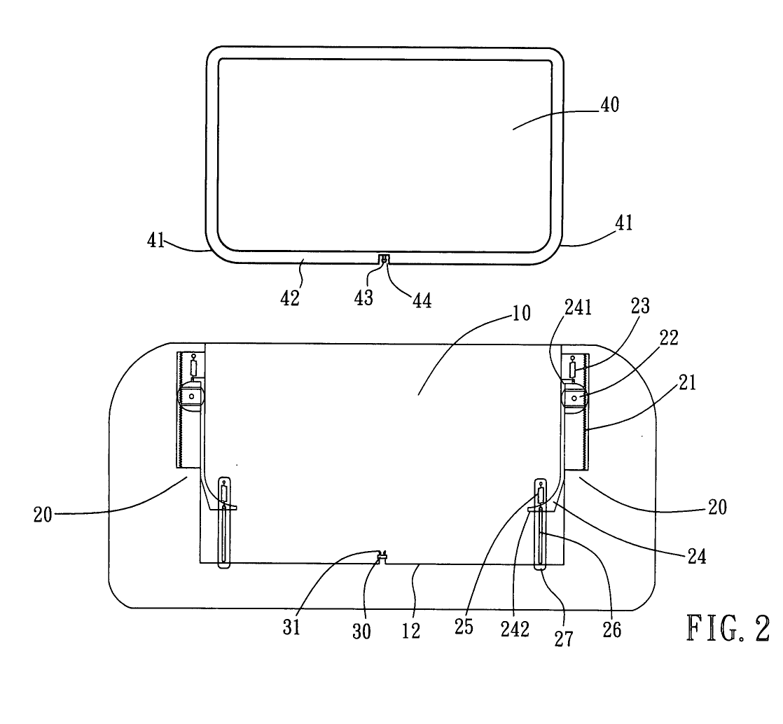

Please refer to FIGS. 1 and 2. FIG. 1 shows a preferred embodiment of the keyboard slot structure attached to the bottom of a monitor 1 and FIG. 2 shows the keyboard slot structure comprises a keyboard slot 10 and a keyboard 40 which can be stored into the keyboard slot 10. The keyboard slot 10 provides enough storage space for keyboard 40, and on its lengthwise side, there is an opening 11.

On the two lateral sides of the keyboard slot 10, there are two automatic outward gliding devices 20 for the keyboard. On the appropriate location of the internal side 12 facing to the opening 11 of the keyboard slot 10, there is a press button 30.

The automatic outward gliding device 20 includes a plurality of dampers 22 and a plurality of keyboard corner pusher 24. The damper 22 can move forward and backward on the rack 21. On the external side of the damper 22 locates a return spring 23 which can pull the damper 22 back. The keyboard corner pusher 24 is an L-type part for the corner 41 of keyboard 40 crutching. The external side 241 of keyboard corner pusher 24 is fixed on the damper 22, and on its internal side 242, there is an auxiliary return spring 25, around which is a leading plate 27 of the movable slot 26. The fixed spring rod 243 is set up on the internal side end 242 of the keyboard corner pusher 24 and cross the movable slot 26, and it can guide and limit the keyboard corner pusher 24 to move a direction of forward and backward only.

The press button 30 is a conventional press button, as shown on FIG. 2, and it mainly consists of two clamps 31 which open and close reciprocally.

The keyboard 40 comprises a conventional keyboard, but on the external edge 42 of keyboard locates a fixation column 43, which is corresponding to the press button 30.

In this preferred embodiment, a fillister 44 with appropriate opening is set up on the external edge corresponding to the press button of the keyboard 40 firstly, and then the fixation column 43 is set up on the middle bottom of the fillister 44.

The fixation column 43 can also be directly set up on the proper location of the external edge of the keyboard 40.

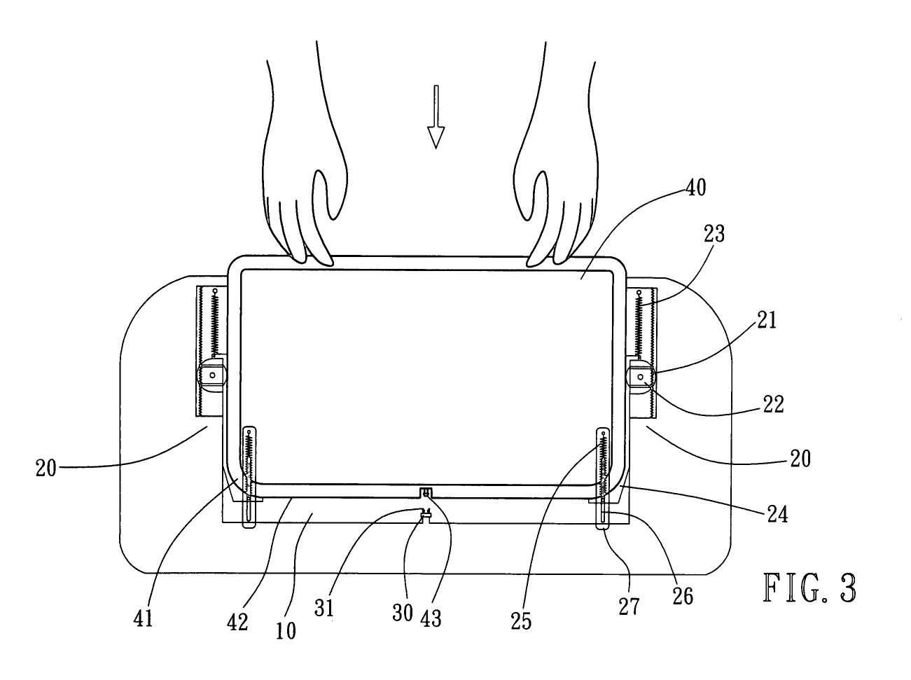

FIGS. 3 to 5 show the operating views of the present invention, in which the keyboard 40 is pushed into the keyboard slot 10 from the opening 11, the two corners 41 of the keyboard 40 will crutch the keyboard corner pushers 24 set on the both sides of the keyboard slot 10. Now if the keyboard 40 is pushed inside slightly, the keyboard corner pusher 24 will move in with the damper 22, and draw the return spring 23 and the auxiliary return spring 25, then the fixation column 43 will also approach the press button 30. The clamps 31 on the press button 30 should be open reciprocally while the fixation column 43 is not in contact with the press button 30, as shown in FIG. 3.

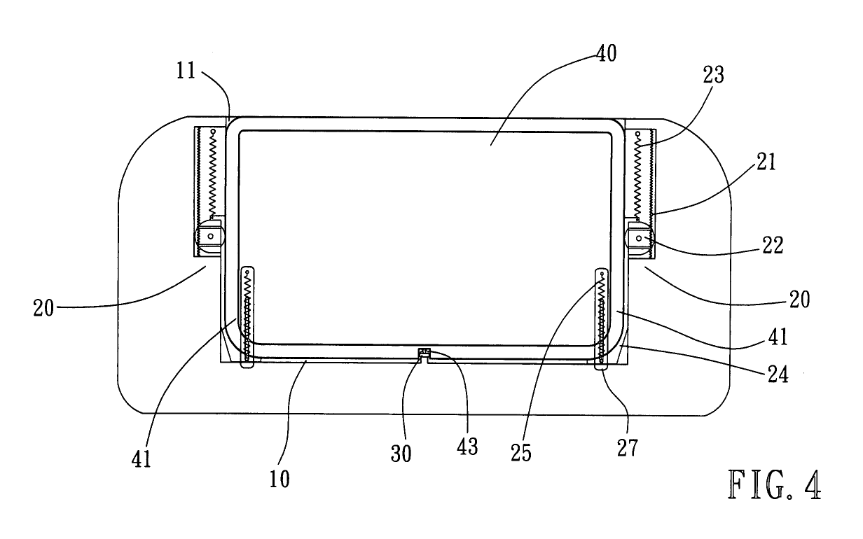

If the fixation column 43 is in contact with the press button 30, it can further push the press button 30 in, until these two clamps 31 are closed and hold the fixation column 43. Now the keyboard 40 is placed and fixed into the keyboard slot 10. The return spring 23 and the auxiliary return spring 25 should be at their most tension, as shown in FIG. 4.

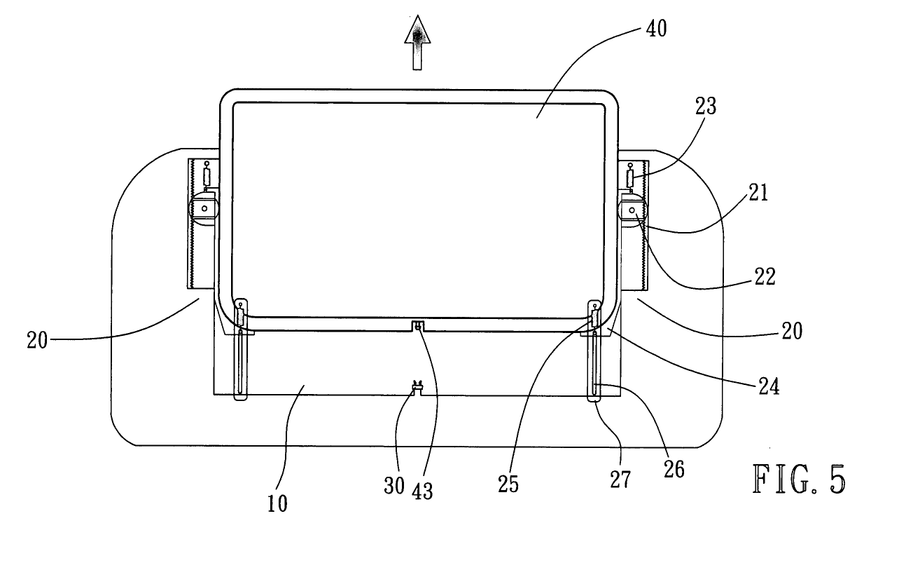

To take out the keyboard 40 for use, simply press the keyboard 40 slightly, and the clamps 31 of the press button 30 will re-open to release the fixation column 43 of the keyboard 40. Now the keyboard 40 can be pushed out by the return spring 23 and the auxiliary return spring 25 which force the keyboard corner pusher 24 to move out, as shown in FIG. 5. The dampers 22 can slow down the speed of the keyboard corner pushers 24. Finally, users can take the keyboard 40 out for use.

Although the invention has been explained in relation to its preferred embodiment, it is to be understood that many other possible modifications and variations can be made without departing from the spirit and scope of the invention as hereinafter claimed.

What is claimed is:

1. A keyboard slot structure attached on the computer peripheral, comprising:
a keyboard slot provided a storage space and having an opening on the lengthwise side of said keyboard slot, wherein the two lateral sides of said keyboard slot have two automatic outward gliding devices and a press button located properly on the internal side corresponding to said opening of said keyboard slot; and
a keyboard, wherein the external edge of said keyboard locates a fixation column corresponding to said press button.

2. The structure as claimed in claim 1, wherein said keyboard slot can be attached to the proper location of the bottom of a display.

3. The structure as claimed in claim 1, wherein said automatic outward gliding device, including:
a plurality of dampers, wherein the external side of said damper is equipped with a return spring; and
a plurality of keyboard corner pushers, wherein said keyboard corner pusher is an L-type part; the external side of said keyboard corner pusher is fixed on said damper, and the internal side of said keyboard corner pusher has an auxiliary return spring.

4. The structure as claimed in claim 3, wherein said auxiliary return spring further comprises a plate of the movable slot.

5. The structure as claimed in claim 1, wherein said fixation column is protruding on the external edge of said keyboard.

6. The structure as claimed in claim 1, wherein a fillister with appropriate opening is further set up on the external edge corresponding to said press button of said keyboard, and then said fixation column is set up on the middle bottom of said fillister.
